(19) United States
(12) Patent Application Publication
(10) Pub. No.: US 2026/0264259 A1
(43) Pub. Date: Sep. 10, 2026

(54) SOLAR MODULE RAILS FOR AUTOMATED SOLAR MODULE INSTALLATION

(71) Applicant: Nextpower LLC, Fremont, CA (US)

(72) Inventors: David Fred Bullock, Grants Pass, OR (US); Alexander W. AU, Oakland, CA (US); Ricardo Delgado-Nanez, San Jose, CA (US); Madeleine Davis Kho, Oakland, CA (US); Yiwei Jiang, Hayward, CA (US); Ning Liu, Folsom, CA (US); Craig Bradley Edward Wildman, Kensington, CA (US); Ryan Patel, Pleasanton, CA (US)

(21) Appl. No.: 19/558,851

(22) Filed: Mar. 6, 2026

Related U.S. Application Data
(60) Provisional application No. 63/769,394, filed on Mar. 10, 2025.

(51) Int. Cl. B25J 11/00; H02S 20/32

(52) U.S. Cl. CPC B25J 11/005; H02S 20/32

(57) ABSTRACT

Disclosed herein are devices, systems, and methods for solar module frames and installation of solar module frames and/or support rails at solar generation installations, such as at a solar tracker. At a support rail interfacing with a solar module frame, a tab at the support rail is moved from a first tab position to a second tab position. When the tab is moved to the second tab position, a fastening member is actuated at the solar module frame and at the tab in the second tab position to couple the solar module frame to the support rail.

### RELATED APPLICATION

This application claims the benefit of U.S. Provisional Patent Application No. 63/769,394, filed Mar. 10, 2025, the entire contents of which are incorporated herein by reference.

### TECHNICAL FIELD

This disclosure relates generally to solar power generation systems, and more particularly, to solar module frames and/or solar module rails having one or more features thereat for autonomous installation at a solar tracker.

### BACKGROUND

Solar modules can convert sunlight into energy. As an example, solar thermal panels often convert electromagnetic radiation from the sun into thermal energy for heating homes, running certain industrial processes, or driving high grade turbines to generate electricity. As another example, solar photovoltaic panels convert sunlight directly into electricity for a variety of applications. Accordingly, solar panels have great potential to benefit our nation, security, and human users. They can even diversify our energy requirements and reduce the world's dependence on oil and other potentially detrimental sources of energy.

Solar modules are generally composed of an array of solar cells, which are interconnected to each other. The cells are often arranged in series and/or parallel groups of cells in series. The solar cells may comprise a solar tracker. A solar tracker is typically comprised of a torque tube that supports the solar modules and is itself supported by piers embedded into the ground. In many cases, solar trackers have been developed that are quite large, spanning hundreds of feet in length and including hundreds of individual solar modules that are mechanically coupled to support structures.

Coupling the numerous solar modules to the support structure requires a significant number of clamps or other mechanisms, each requiring a significant number of fasteners, driving up the cost of manufacturing each mechanism. As can be appreciated, assembling each of these mechanisms and securely tightening each fastener requires an enormous amount of time, contributing to increased cost and longer assembly time.

In view of these costly processes and designs, fastening mechanisms and methods that alleviate the need for costly and time-consuming processes, and reduce the amount of material and labor required for installation are needed.

### SUMMARY

In general, the present disclosure relates to support structures for solar arrays within a solar tracking system.

One embodiment includes a method of coupling one or more solar module frames to one or more support rails. This method embodiment includes the steps of: moving a tab at a support rail from a first tab position to a second tab position, the support rail interfacing with a solar module frame; and when the tab is moved to the second tab position, actuating a fastening member at the solar module frame and at the tab in the second tab position.

In a further embodiment of this method, tab is spaced further from the solar module frame in the first tab position than in the second tab position. For example, moving the tab from the first tab position to the second tab position can include moving the tab closer to the solar module frame. For instance, the tab can be moved from the first tab position to the second tab position by at least folding the tab toward the solar module frame. In some such instances, the tab can include a perforated region configured to induce folding of the tab, and folding the tab toward the solar module frame can include folding the tab about the perforated region. In some additional or alternative such instances, folding the tab toward the solar module frame can include folding the tab from the first tab position that is generally orthogonal to the solar module frame and generally orthogonal to a torque tube at which the support rail sits to the second tab position that is over or under the solar module frame and with the tab laying in a plane that is generally parallel to the torque tube at which the support rail sits.

In a further embodiment of this method, when the tab is moved to the second tab position, the fastening member is inserted through each of the solar module frame and the tab that is in the second tab position and actuated at the solar module frame and at the tab in the second tab position. As one example, the fastening member includes a threaded fastener. Such threaded fastener can be configured to threadingly engage the tab and the solar module frame.

In a further embodiment of this method, a tool is engaged at the tab to move the tab from the first tab position to the second tab position. And, after the tool has been used to move the tab to the second tab position and while the tool is engaged at the tab, the fastening member is actuated at the solar module frame and at the tab in the second tab position using the tool. In some such examples, the support rail can include a locating tab, and engaging the tool at the tab to move the tab includes using the locating tab at the support rail to position the tool in engagement with the tab. For instance, the support rail can include a pilot hole, and engaging the tool at the tab to move the tab includes using the locating tab at the support rail to position the tool both in engagement with the tab and aligned with the pilot hole. In some examples, the tool engages the tab at a notch of the tool to fold the tab from the first tab position to the second tab position, and, after folding the tab from the first tab position to the second tab position and while the tab is engaged at the notch of the tool, the fastening member is actuated through the notch and into the solar module frame and tab at the second tab position. In some examples, the tool includes a robotic tool having a first arm tool and a second arm tool. The tab can be a first tab of the support rail, and the support rail can further include a second tab at a same side of the support rail as the first tab, with the first arm tool engaging the first tab at a first notch of the first arm tool to fold the first tab from the first tab position to the second tab position, and, with the second arm tool, engaging the second tab at a second notch of the second arm tool to fold the second tab from the first tab position to the second tab position, and, after folding the second tab to the second tab position and while the second tab is engaged at the second notch of the second arm tool, actuating a second fastening member at the solar module frame and at the second tab in the second tab position. In one particular such example, the first arm tool and the second arm tool simultaneously engage and fold the respective first and second tabs.

Another embodiment includes a robotic tool for coupling a solar module frame to a support rail of a solar tracker. This robotic tool embodiment includes a notch and a fastening member driver. The notch is configured to receive a tab of a support rail, and, when the tab is received at the notch, the tool is configured to fold the tab toward the solar module frame. The fastening member driver is aligned with the notch to drive a fastening member into the notch and through the tab when the tab is folded toward the solar module frame.

In a further embodiment of this tool, the notch is a first notch and the fastening member driver is a first fastening member driver, and the robotic tool further comprises: a first arm comprising the first notch and the first fastening member driver; and a second arm spaced apart from the first arm, the second arm comprising: a second notch that is configured to receive a second tab of the support rail, wherein, when the second tab is received at the second notch, the second arm is configured to fold the second tab toward the solar module frame, and a second fastening member driver aligned with the second notch to drive a second fastening member into the second notch and through the second tab when the second tab is folded toward the solar module frame.

Another embodiment includes a method of coupling one or more solar module frames to one or more support rails. This method embodiment includes the steps of: placing a solar module frame at a support rail, wherein the solar module frame comprises a coupling region that includes an increased profile thickness relative to an adjacent region at the solar module frame, wherein the support rail is configured to sit at a torque tube of a solar tracker; and after the solar module frame has been placed at the support rail, actuating a fastening member at the support rail and at the coupling region at the solar module frame.

In a further embodiment of this method, the fastening member includes a threaded fastener.

In a further embodiment of this method, the coupling region at the solar module frame includes a back plate member installed at the solar module frame prior to placing the solar module frame at the support rail.

In a further embodiment of this method, the coupling region at the solar module frame includes a C-clip member installed at the solar module frame prior to placing the solar module frame at the support rail.

The details of one or more examples are set forth in the accompanying drawings and the description below. Other features, objects, and advantages will be apparent from the description and drawings, and from the claims.

### BRIEF DESCRIPTION OF DRAWINGS

The following drawings are illustrative of particular embodiments of the present disclosure and, therefore, do not limit the scope of the disclosure. The drawings are intended for use in conjunction with the explanations in the following description. Embodiments of the disclosure will hereinafter be described in conjunction with the appended drawings, wherein like numerals denote like elements. The features illustrated in the drawings are not necessarily to scale, though embodiments within the scope of the present disclosure can include one or more of the illustrated features at the scale shown. Various aspects and features of the present disclosure are described hereinbelow with reference to the drawings, wherein:

FIG. 1 is an elevation view of a solar tracker provided in accordance with the present disclosure;

FIG. 2 is a schematic, top view of a solar tracking system;

FIG. 3 is an elevation view of a torque tube including a plurality of support rails;

FIG. 4 is a schematic, perspective view of a support rail in accordance with the present disclosure;

FIGS. 5A to 5D depict a method of coupling one or more solar module frames to one or more support rail;

FIGS. 6A to 6B are a second illustration of the method, as in FIGS. 5A to 5D;

FIGS. 7A to 7C are an enlarged view illustration of the method, as in FIGS. 5A to 5D;

FIG. 8A is a top, perspective view of another method of coupling a solar module frame to a support rail;

FIG. 8B is a bottom view of a first end of the support rail, as in FIG. 8A;

FIG. 9A is a top, perspective view of another method of coupling a solar module frame to a first end of a support rail;

FIG. 9B is a bottom view of the first end of the support rail, as in FIG. 9A;

FIG. 10A is a schematic, perspective view of a first end of another example support rail in accordance with the present disclosure;

FIG. 10B is a schematic, perspective view of a first end of another example support rail in accordance with the present disclosure;

FIG. 10C is a schematic, perspective view of a second end of another example support rail in accordance with the present disclosure;

FIG. 11 is a flow chart of a method of coupling a solar module frame to a support rail;

FIG. 12A is a solar module frame in accordance with the disclosure;

FIG. 12B is the solar module frame, as in FIG. 12A, coupled to a support rail;

FIG. 13 is a flow chart of a method of coupling the solar module frame, as in FIG. 12A, to a support rail;

FIG. 14A is a solar module frame in accordance with the disclosure;

FIG. 14B is the solar module frame, as in FIG. 14A, prior to coupling to a support rail;

FIG. 14C is the solar module frame, as in FIG. 14A, coupled to the support rail, as in FIG. 14B;

FIG. 15A is a solar module frame in accordance with the disclosure;

FIG. 15B is a side end view of the solar module frame, as in FIG. 15A;

FIG. 15C is a top side view of the solar module frame, as in FIG. 15A;

FIG. 15D is a top side view of a plurality of solar module frames, as in FIG. 15A, configured for packaging;

FIG. 16A is a solar module frame in accordance with the disclosure;

FIG. 16B is the solar module frame, as in FIG. 16A, prior to coupling to a support rail;

FIG. 16C is the solar module frame, as in FIG. 16A, coupled to the support rail, as in FIG. 16B;

FIG. 17 is a flow chart of a method of coupling the solar frame, as in FIGS. 14A, 15A, and 16A, to a support rail; and

FIG. 18 is a flow chart of a second method of coupling the solar frame, as in FIGS. 14A, 15A, and 16A, to a support rail.

### DETAILED DESCRIPTION

The following detailed description is exemplary in nature and is not intended to limit the scope, applicability, or configuration of the disclosure in any way. Rather, the following description provides some practical illustrations for implementing examples of the present disclosure. Those skilled in the art will recognize that many of the noted examples have a variety of suitable alternatives.

The following disclosure will describe various solar module frame embodiments that can be used, for instance, in a solar tracker apparatus. Such embodiments disclosed herein can, for example, be useful in facilitating more labor-efficient solar module frame installation at a solar tracker apparatus. The following description will describe a variety of solar module frame embodiments as well as associated frame coupling apparatuses for coupling one or more solar module frames to a support structure, which in the solar tracker apparatus example applications provided here is a torque tube.

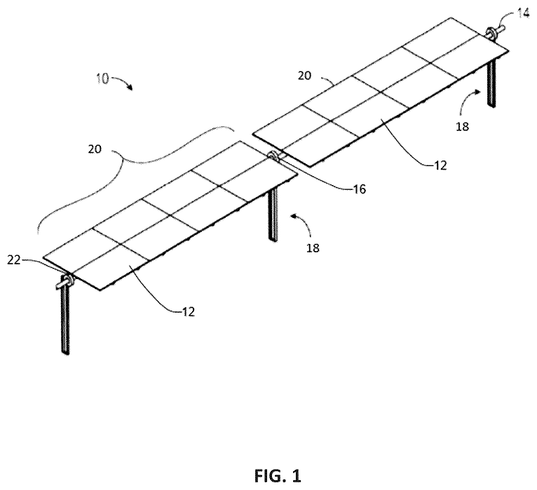

FIG. 1 is an elevation view of a common arrangement of a solar tracker 10 provided in accordance with the present disclosure. In some applications, a plurality of solar trackers 10 may be arranged in a north-south longitudinal orientation to form rows of a solar array. The solar tracker 10 may be formed of a plurality of bays 20 defined by the distance between ground pile support structures 18 (generally referenced herein as piles 18). The ground piles 18 may be disposed in spaced relation to one another and partially embedded in the earth. In some examples, the ground piles 18 may be multi-component tubular support members, or A-frame supports, and/or may be configured to couple to A-frame supports. The piles 18 may have one or more embedments in the ground, such as one for each leg of an A-frame support where the embedments are spaced apart in the east-west direction. FIG. 1 illustrates two bays 20 of the solar tracker 10. However, it will be appreciated that the solar tracker 10 may include four bays, six bays, ten bays, twenty bays, or any other suitable number of bays as desired. At each pile 18 is either a bearing 22 or generally near the center of the solar tracker 10 a drive mechanism 16.

Each of the bearings 22 and the drive mechanism 16 are supported by one of the piles 18.

Activation of the drive mechanism rotates a torque tube 14 about an axis of rotation and thus rotates one or more solar modules 12 mounted to the torque tube 14 such that the solar modules 12 can be oriented to a desired position. That desired position may be to a position to capture maximum sunlight based on the location of the sun in the sky, that position may be to a 0-angle position during times of diffuse light, the desired position may be a safety position based on weather conditions such as high winds or a snow storm, or any position in between as desired by the operators of the solar power plant in which the solar tracker 10 is located given the current weather and atmospheric conditions, the current demands of the grid, and other factors. The bearings 22 reduce to the extent possible the resistance to movement of the torque tube 14 and the solar modules 12.

The torque tube 14 is sized (e.g., diameter, wall thickness, material) such that sag between the piles 18 is reduced and to absorb torsional loads applied to the torque tube 14 by wind loading. In addition, since there is often just a single drive mechanism 16, the specifications for the torque tube 14 may desire to eliminate twist of the torque tube 14 along its length. Any twist would result in the solar modules 12 being oriented differently from what is desired, and thus again reduce the output and efficiency of the solar tracker 10, particularly, as the solar tracker 10 is rotated to the extreme angles of permitted range (e.g., +/−75 degrees or more), for example, during stowing.

As will be appreciated, the solar modules 12 must be supported on the torque tube 14. This is typically achieved by a bracket system (not shown in FIG. 1) that is attached to the torque tube 14 substantially perpendicular to the longitudinal axis of the torque tube 14. The torque tube 14 may be rotatable about its longitudinal axis to adjust an angular orientation of the solar modules 12 relative to the sun, while supporting the solar modules 12 on the bracket system. The bracket system may take many forms including two pieces of shaped steel, which may be arranged to sandwich the solar modules 12, and may be configured to connect to a rail, which is then coupled to the torque tube 14.

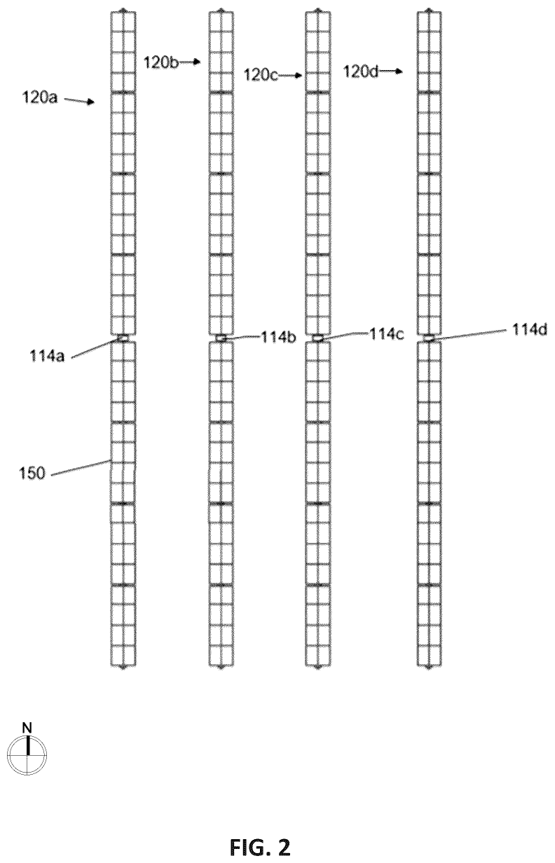

FIG. 2 is a top view of a solar tracker system 100 composed of a plurality of solar tracker rows, such as for example, a first solar tracker row 120a, a second solar tracker row 120b, a third solar tracker row 120c, and a fourth solar tracker row 120d (generally referred to herein as solar tracker rows 120). The solar tracker rows 120 may be arranged in parallel in a north-south direction, as shown in FIG. 2. It will be appreciated that directional language, e.g., north, south, east, west, referenced herein, is referring generally to such directions and not necessarily to the precise direction. For example, north-south, east-west directions may mean true north-south, true east-west, or approximately north, approximately south, approximately east, or approximately west, for example, within a ±44° range of true north-south, east-west. In some cases, the solar tracker rows 120 may include interior solar tracker rows, such as for example, solar tracker rows 120b, 120c, and exterior solar tracker rows, such as for example, solar tracker rows 120a, 120d. It will be appreciated that interior solar tracker rows are solar tracker rows 120 positioned between two other solar tracker rows 120, and exterior solar tracker rows are solar tracker rows 120 with one other solar tracker row 120 on one side of the exterior solar tracker row and no solar tracker row 120 positioned on the other side, opposite the one side of the exterior solar tracker row. The solar tracker rows 120 may be composed of a plurality of solar module assemblies 150 arranged in a north-south longitudinal orientation to form the solar tracker rows 120. The solar module assemblies 150 may include a plurality of solar modules, such as the solar modules 12, as in FIG. 1. Each one of the plurality of solar module assemblies 150 may be supported on a torque tube 114a, 114b, 114c, 114d (generally referred to herein as torque tube 114), which in turn is supported by a plurality of support piers (not explicitly shown in FIG. 2). The torque tube 114 may be an example of the torque tube 14, as in FIG. 1. As shown, the solar tracker rows 120 may be separated by a space sufficient to allow machinery to travel therethrough to allow for cleaning and maintenance.

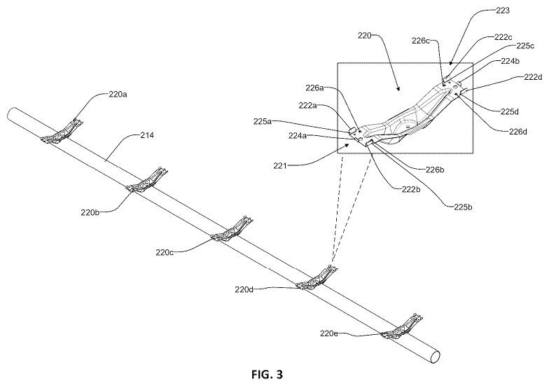

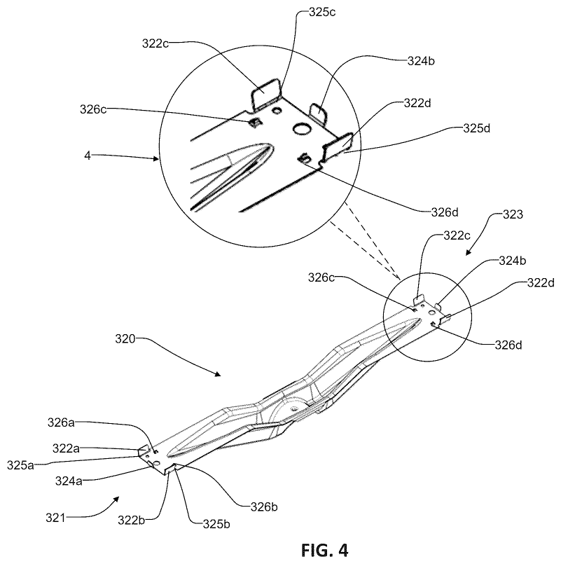

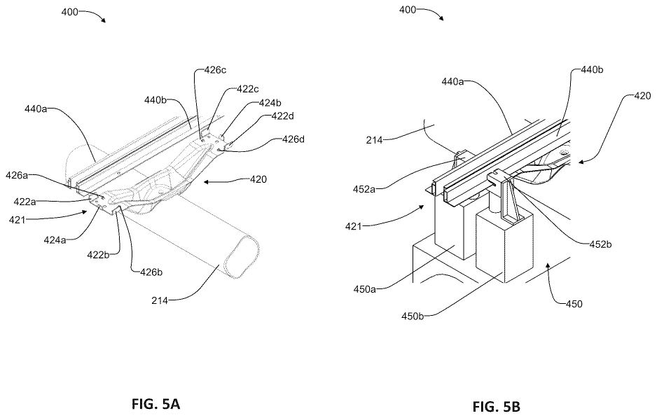

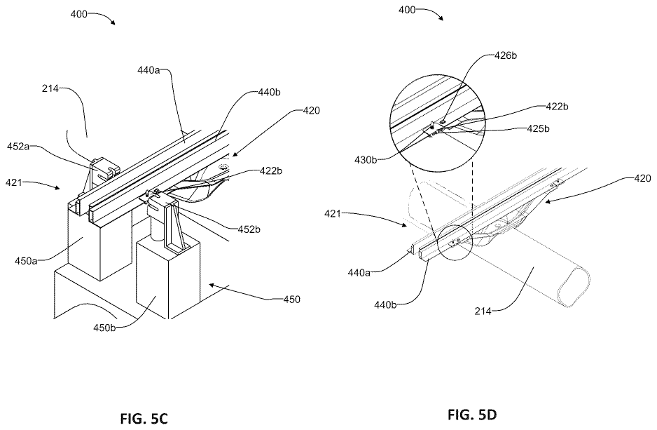

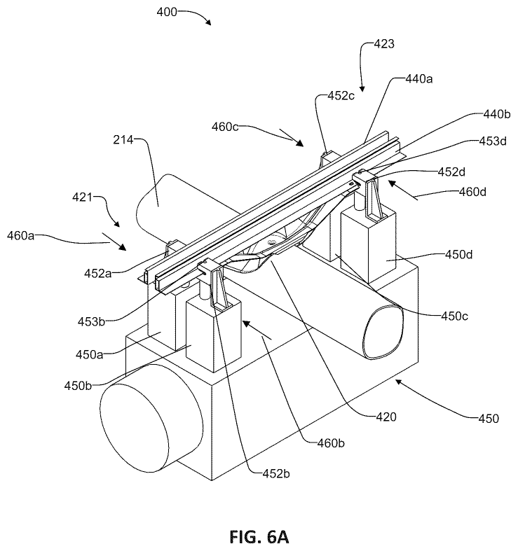

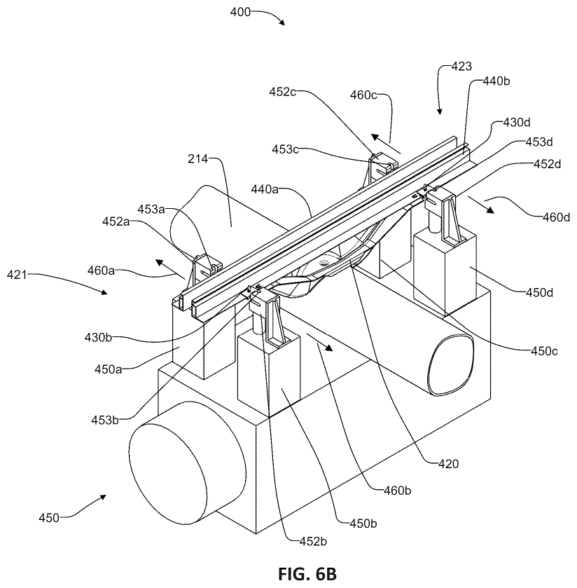

FIG. 3 is an elevation view of a torque tube 214 including a plurality of support rails 220a, 220b, 220c, 220d, 220e. The plurality of support rails 220a, 220b, 220c, 220d, 220e may be generally referred to herein as support rail 220. The support rail 220 may be configured to be secured to the torque tube 214 via a strap assembly, although this is not explicitly shown. The support rail 220 may define a first end 221 and a second end 223. The first end 221 of the support rail 220 may include a first tab 222a, a second tab 222b, and a first spacer 224a. The first tab 222a may include a first perforated region 225a and the second tab 222b may include a second perforated region 225b. The perforated regions will be shown in further detail with reference to FIG. 4. The first perforated region 225a and the second perforated region 225b may enable each of the first tab 222a and the second tab 222b to fold inward toward the first spacer 224a. As will be shown in further detail with reference to FIGS. 5A to 6B, folding of each of the first tab 222a and the second tab 222b positions the first tab 222a and the second tab 222b to interface with (e.g., positions the first tab 222a and the second tab 222b over or under) a solar module frame to help secure the solar module frame (e.g., solar module) to the torque tube 214. The first end 221 of the support rail 220 may further include a first location tab 226a and a second location tab 226b. The first location tab 226a and the second location tab 226b may include a profile greater than a profile of the support rail 220 (e.g., greater height extending out from top side of rail). The first location tab 226a and the second location tab 226b may be configured to align with one or more holes within a solar module frame when the solar module frame is positioned in the correct location. The alignment of the location tabs 226a, 226b with the one or more holes within the solar module frame may further serve to hold the solar module frame in position if the solar tracker module is tilted at an angle for easier access for fastener installation.

The second end 223 of the support rail 220 may include a third tab 222c, a fourth tab 222d, and a second spacer 224b. The third tab 222c may include a third perforated region 225c and the fourth tab 222d may include a fourth perforated region 225d. The perforated regions will be shown further with reference to FIG. 4. The third perforated region 225c and the fourth perforated region 225d may enable each of the third tab 222c and the fourth tab 222d to fold inward toward the second spacer 224b. As will be shown in further detail with reference to FIGS. 5A to 6B, folding of each of the third tab 222c and the fourth tab 222d positions the third tab 222c and the fourth tab 222d over a solar module frame to help secure the solar module frame (e.g., solar module) to the torque tube 214. The second end 223 of the support rail 220 may further include a third location tab 226c and a fourth location tab 226d. The third location tab 226c and the fourth location tab 226d may include a profile greater than a profile of the support rail 220. The third location tab 226c and the fourth location tab 226d may be configured to align with one or more holes within a solar module frame when the solar module frame is positioned in the correct location. The alignment of the location tabs 226c, 226d with the one or more holes within the solar module frame may further serve to hold the solar module frame in position if the solar tracker module is tilted at an angle for easier access for fastener installation.

While it is shown that there is the first tab 222a, second tab 222b, third tab 222c, and fourth tab 222d, it may be contemplated that there may be five, six, eight, ten, or any other suitable number of tabs as desired. Further, while it is shown that there may be the first location tab 226a, second location tab 226b, third location tab 226c, and fourth location tab 226d, it may be contemplated that there may be six, eight, ten, or any other suitable number of location tabs as desired. In some examples, the location tabs 226a, 226b, 226c, 226d may be formed in the support rail 220 via stamping, laser cutting, drilling, or any other suitable method. In other examples, it may be contemplated that the location tabs are omitted.

FIG. 4 is a schematic, perspective view of a support rail 320 in accordance with the present disclosure. The support rail 320 may be an example of the support rail 220 shown in FIG. 3. The support rail 320 may define a first end 321 and a second end 323. The first end 321 of the support rail 320 may include a first tab 322a, a second tab 322b, and a first spacer 324a. The first tab 322a may include a first perforated region 325a and the second tab 322b may include a second perforated region 325b. The first perforated region 325a and the second perforated region 325b may enable each of the first tab 322a and the second tab 322b, respectively, to fold inward toward the first spacer 324a. As will be shown in further detail with reference to FIGS. 5A to 6B, folding of each of the first tab 322a and the second tab 322b positions the first tab 322a and the second tab 322b over a solar module frame to help secure the solar module frame (e.g., solar module) to a torque tube, e.g., torque tube 214. The first end 321 of the support rail 320 may further include a first location tab 326a and a second location tab 326b. The first location tab 326a and the second location tab 326b may include a profile greater than a profile of the support rail 320. The first location tab 326a and the second location tab 326b may be configured to align with one or more holes within a solar module frame when the solar module frame is positioned in the correct location. The alignment of the location tabs 326a, 326b with the one or more holes within the solar module frame may further serve to hold the solar module frame in position if the solar tracker module is tilted at an angle for easier access for fastener installation.

The second end 323 of the support rail 320 may include a third tab 322c, a fourth tab 322d, and a second spacer 324b. The third tab 322c may include a third perforated region 325c and the fourth tab 322d may include a fourth perforated region 325d, as shown in further detail in Circle A. The third perforated region 325c and the fourth perforated region 325d may reduce the amount of force required to bend (e.g., fold) the third tab 322c and the fourth tab 322d, respectively, and enable each of the third tab 322c and the fourth tab 322d to fold inward toward the second spacer 324b. While the first end 321 of the support rail 320 is not shown in an enlarged view, it will be appreciated that the description of the second end 323 of the support rail 320 further applies to the first end 321 of the support rail 320.

Folding of each of the third tab 322c and the fourth tab 322d positions the third tab 322c and the fourth tab 322d over a solar module frame to help secure the solar module frame (e.g., solar module) to a torque tube, e.g., torque tube 214. The second end 323 of the support rail 320 may further include a third location tab 326c and a fourth location tab 326d. The third location tab 326c and the fourth location tab 326d may include a profile greater than a profile of the support rail 320. The third location tab 326c and the fourth location tab 326d may be configured to align with one or more holes within a solar module frame when the solar module frame is positioned in the correct location. The alignment of the location tabs 326c, 326d with the one or more holes within the solar module frame may further serve to hold the solar module frame in position if the solar tracker module is tilted at an angle for easier access for fastener installation.

While it is shown that there is the first tab 322a, second tab 322b, third tab 322c, and fourth tab 322d, it may be contemplated that there may be five, six, eight, ten, or any other suitable number of tabs as desired. Further, while it is shown that there may be the first location tab 326a, second location tab 326b, third location tab 326c, and fourth location tab 326d, it may be contemplated that there may be six, eight, ten, or any other suitable number of location tabs as desired. In some examples, the location tabs 326a, 326b, 326c, 326d may be formed in the support rail 320 via stamping, laser cutting, drilling, or any other suitable method. In other examples, it may be contemplated that the location tabs are omitted.

FIGS. 5A to 5D depict a method 400 of coupling a first solar module frame 440a and a second solar module frame 440b to a support rail 420 coupled to the torque tube 214. The support rail 420 may be an example of the support rail 220, as shown in FIG. 3, and/or the support rail 320, as shown in FIG. 4. It will be appreciated that the description of the support rails 220, 320 further applies to the support rail 420.

As can be seen, FIGS. 5A to 5D are showing only one portion of each of the first solar module frame 440a and the second solar module frame 440b, at a first end 421 of the support rail 420. It will be appreciated that the description of the first end 421 of the support rail 420 in FIGS. 5A to 5D further applies to a second end 423 of the support rail 420 (shown in FIGS. 6A to 6B). In some examples, as shown in FIGS. 5A to 5D, the support rail 420 may be configured to couple both the first solar module frame 440a and the second solar module frame 440b to the torque tube 214. The first solar module frame 440a and the second solar module frame 440b may be configured to bind solar modules including a plurality of photovoltaic cells (not explicitly shown) within the confines of the solar module frames 440a, 440b. In some examples, the first solar module frame 440a and the second solar module frame 440b may be formed from an extruded aluminum and may include a thickness of about 1 millimeter (mm) to about 1.5 mm.

As shown in FIG. 5A, the first solar module frame 440a and the second solar module frame 440b may be aligned over and/or on the support rail 420 such that a first spacer 424a and a second spacer 424b are positioned between the first solar module frame 440a and the second solar module frame 440b. Upon lowering the first solar module frame 440a and the second solar module frame 440b onto the support rail 420, a robotic tool 450 having a first arm 450a and a second arm 450b may advance to location of the support rail 420 and aid in coupling the first solar module frame 440a and the second solar module frame 440b to the support rail 420, as shown in FIG. 5B. While it is shown that the robotic tool 450 may only include the first arm 450a and the second arm 450b, it may be contemplated that the robotic tool 450 further includes a third arm and a fourth arm, as shown in FIGS. 6A to 6B.

In use, the robotic tool 450 may include one or more sensors directing the robotic tool 450 to the desired location. In this example, the desired location is the support rail 420 positioned along the torque tube 214. Once the robotic tool 450 has arrived at the desired location, the first arm 450a and the second arm 450b of the robotic tool 450 advance toward the support rail 420 and the first solar module frame 440a and the second solar module frame 440b, respectively. The first arm 450a may include a first head 452a that locates a first tab 422a of the support rail 420 and bends (e.g., folds) the first tab 422a inward toward the first spacer 424a and over the first solar module frame 440a. A fastening member, for example a threaded fastener (e.g., threaded fastener 430b shown in FIG. 5D), may be inserted from a bottom of the first arm 450a, which then may pass through the first head 452a, through a pilot hole in the support rail 420, through the first solar module frame 440a, and into the bent first tab 422a. Similarly, the second arm 450b may include a second head 452b that locates a second tab 422b of the support rail 420 and bends (e.g., folds) the second tab 422b inward toward the first spacer 424a and over the second solar module frame 440b. A threaded fastener (e.g., threaded fastener 430b shown in FIG. 5D) may be inserted from a bottom of the second arm 450b, which then may pass through the second head 452b, through a pilot hole in the support rail 420, through the second solar module frame 440b, and into the bent second tab 422b.

The first arm 450a and the second arm 450b may locate the first tab 422a and the second tab 422b, respectively, via a first locating tab 426a (FIG. 5A) and a second locating tab 426b (FIGS. 5A, 5D). In some examples, the first arm 450a and the second arm 450b may locate the first locating tab 426a and the second locating tab 426b via one or more sensors located in the first head 452a and the second head 452b. The sensors may include, for example, a proximity sensor, a position sensor, an image sensor, a light sensor, a pressure sensor, or the like. In some examples, the first arm 450a and the second arm 450b may locate the first locating tab 426a and the second locating tab 426b via a camera within the first head 452a and the second head 452b.

As shown in FIG. 5C, the first head 452a and the second head 452b of the robotic tool 450 may be retracted and lowered toward the first arm 450a and the second arm 450b, respectively. As can be seen, the second tab 422b has been folded over the second solar module frame 440b and a threaded fastener 430b has been placed therethrough, see FIG. 5D. While the second tab 422b is shown in FIGS. 5C to 5D, it will be appreciated that the first tab 422a has also been folded over the first solar module frame 440a and a threaded fastener 430a has been placed therethrough. In some examples, solar module frames formed from aluminum may be thin and therefore somewhat weak. Further, a threaded fastener may melt the aluminum as it is passed through the solar module frames. In such cases, the folded tabs may provide a higher joint strength as well as resist melting as the tabs may be formed from a steel. It will be appreciated that the threaded fasteners (e.g., threaded fasteners 430a, 430b, 430c, 430d) described herein may be any suitable type of threaded fastener, such as, for example, a flow drill screw, a sheet metal screw, machine screws, or the like.

FIGS. 6A to 6B are another illustration of the method 400. As shown in FIGS. 6A to 6B, the robotic tool 450 may include the first arm 450a, the second arm 450b, a third arm 450c, and a fourth arm 450d. The first arm 450a, the second arm 450b, the third arm 450c, and the fourth arm 450d each advance toward the support rail 420 and the first solar module frame 440a (first arm 450a, third arm 450c) and the second solar module frame 440b (second arm 450b, fourth arm 450d), as indicated by arrows 460a, 460b, 460c, 460d. The first head 452a, the second head 452b may each locate the first tab 422a and the second tab 422b, respectively, and bend (e.g., fold) the first tab 422a inward toward the first spacer 424a over the first solar module frame 440a, and the second tab 422b inward toward the first spacer 424a and over the second solar module frame 440b, respectively. Similarly, a third head 452c, and a fourth head 452d may each locate a third tab 422c and a fourth tab 422d, respectively, and bend (e.g., fold) the third tab 422c inward toward a second spacer 424b and over the first solar module frame 440a, and the fourth tab 422d inward toward the second spacer 424b and over the second solar module frame 440b, respectively.

A threaded fastener may be inserted from a bottom of the first arm 450a, which then may pass through the first head 452a, through a pilot hole in the support rail 420, through the first solar module frame 440a, and into the bent first tab 422a. The first head 452a may include a first notch 453a (FIG. 6B) through which the threaded fastener may pass. The first notch 453a allows the threaded fastener to move out of the first arm 450a without any disruption. As with the first arm 450a, a threaded fastener (threaded fastener 430b, 430d) may be inserted from a bottom of the second arm 450b, the third arm 450c, and the fourth arm 450d, which may then pass through the second head 452b, the third head 452c, and the fourth head 452d, respectively, through a pilot hole in the support rail 420, through the first solar module frame 440a (third head 452c) and the second solar module frame 440b (second head 452b, fourth head 452d) and into the bent second tab 422b, the bent third tab 422c, and the bent fourth tab 422d, respectively. The second head 452b may include a second notch 453b, the third head 452c may include a third notch 453c (FIG. 6B), and the fourth head 452d may include a fourth notch 453d through which each of the threaded fasteners may pass. The second notch 453b, the third notch 453c, and the fourth notch 453d each allow the threaded fastener to move out of the respective arms without any disruption. The insertion of the threaded fasteners via the robotic tool 450 may occur concurrently. In some examples, the insertion of the threaded fasteners via the robotic tool 450 may occur at varying times.

As shown in FIG. 6B, once the threaded fasteners have been inserted through the tabs (422a, 422b, 422c, 422d) and the solar module frames 440a, 440b), the first head 452a, the second head 452b, the third head 452c, and the fourth head 452d of the robotic tool 450 may be retracted and lowered toward the first arm 450a, the second arm 450b, the third arm 450c, and the fourth arm 450d, respectively. The first arm 450a, the second arm 450b, the third arm 450c, and the fourth arm 450d may then move away from the desired location, as indicated by arrows 460a, 460b, 460c, 460d, and move on to a next desired location and repeat the process of inserting the threaded fasteners at the next desired location. This process may continue until each solar module frame is coupled to its respective support rail within a solar tracker row.

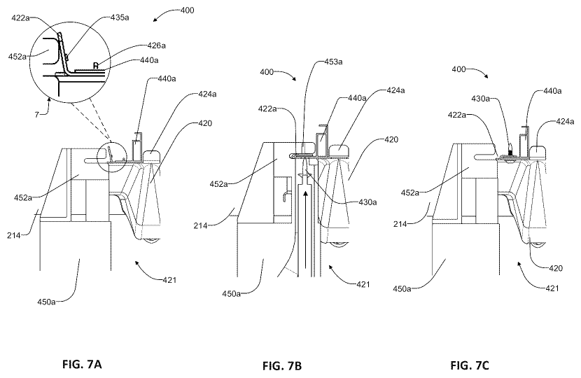

FIGS. 7A, 7B, and 7C are enlarged views of the method 400. FIGS. 7A to 7C are showing the first arm 450a coupling the first solar module frame 440a to the first end 421 of the support rail 420. As shown in FIG. 7A, the first arm 450a may move to the desired location. The first head 452a may locate the first tab 422a of the support rail 420. As shown in Circle B, the first head 452a may generally abut the first tab 422a of the support rail 420. A first grounding feature 435a may be included on the first tab 422a. The first grounding feature 435a may be configured to pierce an anodizing layer of the first solar module frame 440a to enable electrical bonding of the first solar module frame 440a and the support rail 420. While it is shown that there is the first grounding feature 435a included in the first tab 422a, it will be appreciated that each of the second tab 422b, third tab 422c, and fourth tab 422d further include grounding features.

The first head 452a may advance inward toward the first spacer 424a and bend (e.g., fold) the first tab 422a inward toward the first spacer 424a and over the first solar module frame 440a, as shown in FIG. 7B. A threaded fastener 430a may be inserted from a bottom of the first arm 450a, as shown in FIG. 7B, which then may pass through the first head 452a, through a pilot hole in the support rail 420, through the first solar module frame 440a, and into the bent first tab 422a. In such examples, the folding of the first tab 422a over the first solar module frame 440a may form a “sandwich” of support rail 420, first solar module frame 440a, first tab 422a, as shown in FIG. 7C. Upon insertion of the threaded fastener 430a, the first head 452a may retract and lower toward the first arm 450a of the robotic tool 450. As discussed with reference to FIGS. 6A to 6B, the first arm 450a may then move away from the desired location and move on to a next desired location and repeat the process of inserting the threaded fasteners at the next desired location. This process may continue until each solar module frame is coupled to its respective support rail within a solar tracker row.

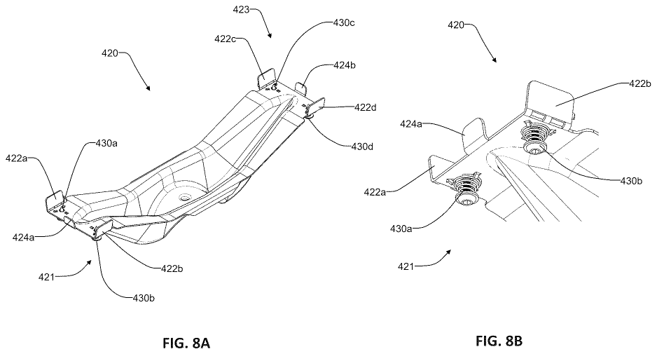

FIG. 8A depicts a top, perspective view of another method of coupling solar module frames (e.g., solar module frames 440a, 440b) to the support rail 420, and FIG. 8B is a bottom view of the first end 421 of the support rail 420 as in FIG. 8A. As previously discussed, the robotic tool 450 may be used to insert threaded fasteners (e.g., threaded fastener 430a, 430b, 430c, 430d) from a bottom of the first arm 450a, as shown in FIG. 7B, which then may pass through the first head 452a, through a pilot hole in the support rail 420, through the first solar module frame 440a, and into the bent first tab 422a. In some examples, however, it may be contemplated that the first threaded fastener 430a, the second threaded fastener 430b, the third threaded fastener 430c, and the fourth threaded fastener 430d may be preinstalled in pilot holes within the support rail 420. In such examples, the robotic tool 450 may not need to insert threaded fasteners, but rather simply screw in the pre-existing threaded fasteners (e.g., threaded fastener 430a, 430b, 430c, 430d). In some examples, the preinstalled threaded fasteners (e.g., threaded fastener 430a, 430b, 430c, 430d) may be manually screwed into place. Further, the preinstalled threaded fasteners (e.g., threaded fastener 430a, 430b, 430c, 430d) may act as a solar module frame (e.g., solar module frames 440a, 440b) positioning guide. While only the first end 421 of the support rail 420 is shown in FIG. 8B, it will be appreciated that the discussion of the details with reference to the first end 421 of the support rail 420 further applies to the second end 423 of the support rail 420.

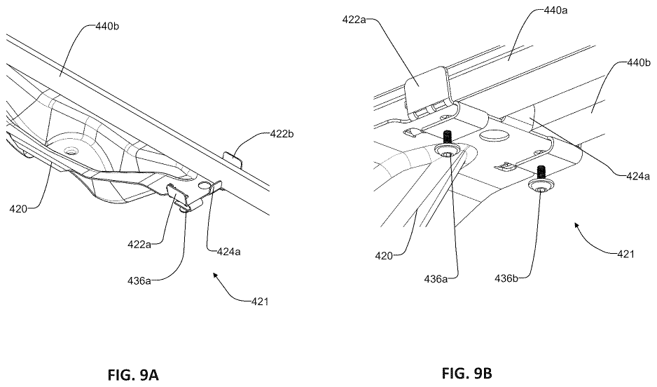

FIG. 9A depicts a top, perspective view of the first end 421 of the support rail 420 depicting another method of coupling the solar module frames (e.g., solar module frames 440a, 440b) to the support rail 420, and FIG. 9B is a bottom view of the first end 421 of the support rail 420 as in FIG. 9A. As previously discussed, the robotic tool 450 may be used to insert threaded fasteners (e.g., threaded fastener 430a, 430b, 430c, 430d) from a bottom of the first arm 450a, as shown in FIG. 7B, which then may pass through the first head 452a, through a pilot hole in the support rail 420, through the first solar module frame 440a, and into the bent first tab 422a In some examples, however, it may be contemplated that a first threaded fastener 436a, a second threaded fastener 436b, and a third and a fourth threaded fastener (not explicitly shown in FIGS. 9A to 9B) may be preinstalled in pilot holes within the support rail 420. In such examples, the robotic tool 450 may not need to insert threaded fasteners, but rather simply screw in the pre-existing threaded fasteners (e.g., threaded fastener 436a, 436b). In some examples, the preinstalled threaded fasteners (e.g., threaded fastener 436a, 436b) may be manually screwed into place. In some examples, the preinstalled threaded fasteners (e.g., threaded fastener 436a, 436b) may be self-tapping screws which do not need to be “screwed” into place. Further, the preinstalled threaded fasteners (e.g., threaded fastener 436a, 436b) may act as the first solar module frame 440a and the second solar module frame 440b positioning guide. While only the first end 421 of the support rail 420 is shown in FIGS. 9A to 9B, it will be appreciated that the discussion of the details with reference to the first end 421 of the support rail 420 further applies to the second end 423 of the support rail 420.

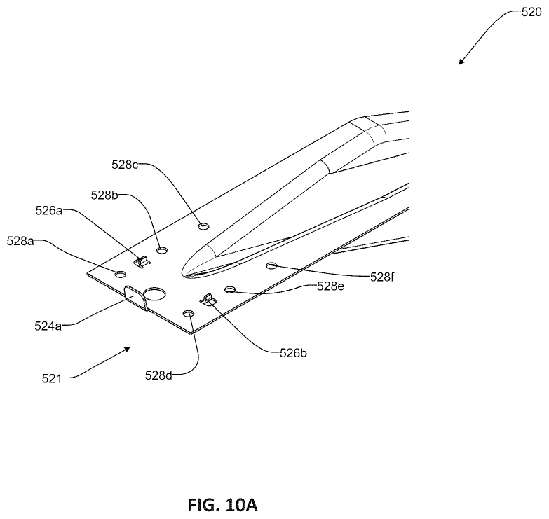

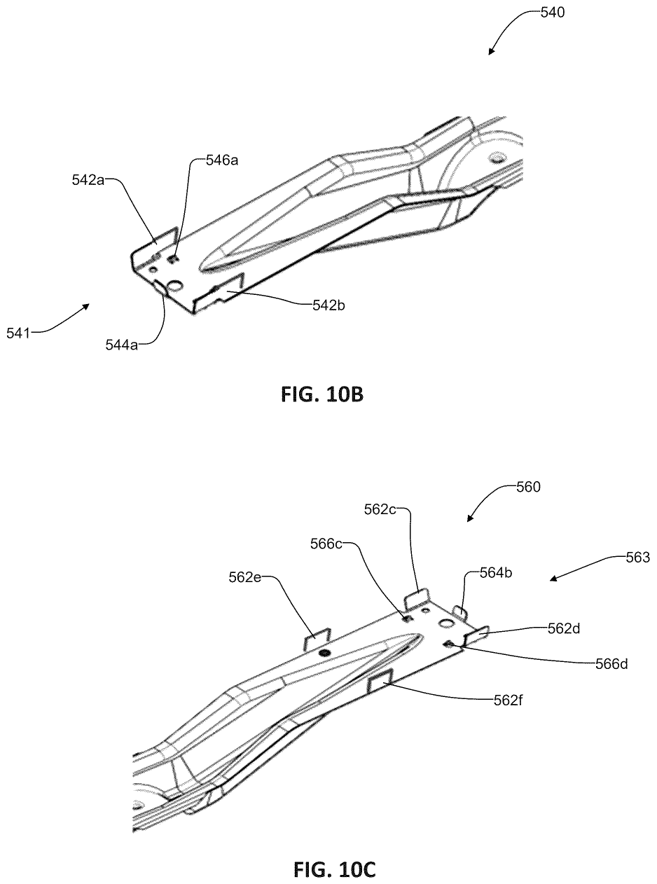

FIG. 10A is a schematic, perspective view of a first end 521 of a support rail 520 in accordance with the present disclosure. While only the first end 521 of the support rail 520 is shown in FIG. 10A, it will be appreciated that the discussion of the details with reference to the first end 521 of the support rail 520 further applies to a second end of the support rail 520. The support rail 520 may be like support rails 220, 320, 420, however, the support rail 520 may differ in the fact that the support rail 520 does not include tabs.

As shown in FIG. 10A, the support rail 520 may include a first mounting hole 528a, a second mounting hole 528b, a third mounting hole 528c, a fourth mounting hold 528d, a fifth mounting hole 528e, and a sixth mounting hole 528f, generally referred to herein as a plurality of mounting holes 528. The support rail 520 may include a first spacer 524a, a first locating tab 526a, and a second locating tab 526b. As previously stated, with reference to FIGS. 5A to 5D, solar module frames formed from aluminum may be thin and therefore somewhat weak. By including the plurality of mounting holes 528, a plurality of threaded fasteners may be inserted into an aluminum solar module frame. The larger number of threaded fasteners may be used to compensate for the weaker strength of the aluminum solar module frame.

FIG. 10B is a schematic, perspective view of a first end 541 of another example support rail 540 in accordance with the present disclosure. While only the first end 541 of the support rail 540 is shown in FIG. 10B, it will be appreciated that the discussion of the details with reference to the first end 541 of the support rail 540 further applies to a second end of the support rail 540. The support rail 540 may be like support rails 220, 320, 420, however, the support rail 540 may differ in the fact that the support rail 540 includes wider tabs. In the example shown in FIG. 10B, a first tab 542a and a second tab 542b may include a width that extends from the first end 541 of the support rail 540 towards a second end such that the first tab 542a and the second tab 542b extend past a first location tab 546a and a second location tab (not shown in FIG. 10B). The wider tabs (e.g., first tab 542a, second tab 542b) may accommodate placement of multiple threaded fasteners, which may be desirable for added strength.

FIG. 10C is a schematic, perspective view of a second end 563 of another example support rail 560 in accordance with the present disclosure. While only the second end 563 of the support rail 530 is shown in FIG. 10C, it will be appreciated that the discussion of the details with reference to the second end 563 of the support rail 560 further applies to a first end of the support rail 560. The support rail 560 may be like support rails 220, 320, 420, however, the support rail 560 may differ in the fact that the support rail 560 includes multiple tabs. In the example shown in FIG. 10C, a third tab 562c, a fourth tab 562d, a fifth tab 562e, and a sixth tab 562f (a first and second tab are not explicitly shown as they are part of a first end of the support rail 560) may be included. While it is discussed that there may be six tabs included in the support rail 560, it may be contemplated that there may be eight tabs, ten tabs, twelve tabs, or any other suitable number of tabs as desired. Including multiple tabs (e.g., six tabs) may accommodate placement of multiple threaded fasteners, which may be desirable for added strength.

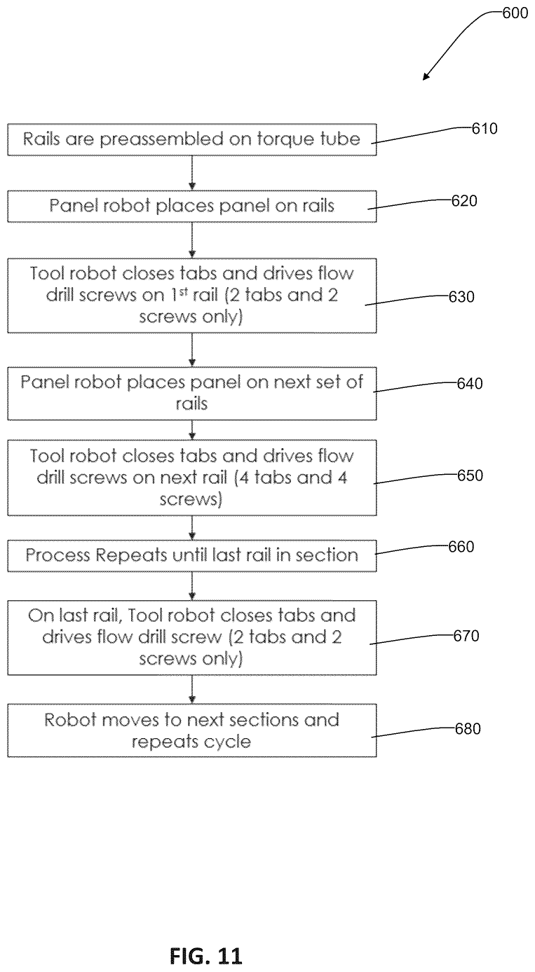

FIG. 11 is a flow chart of a method 600 of coupling a solar module frame (e.g., first solar module frame 440a, second solar module frame 440b) to a support rail (e.g., support rail 220, 320, 420), which is coupled to a torque tube (e.g., torque tube 14, 114, 214). In some examples, the support rails may be preassembled on a torque tube, as referenced by block 610. A panel robot may then place a first set of solar module panels on a first support rail, as referenced by block 620. A robotic tool (e.g., robotic tool 450) may advance to a desired location in a first section of a solar tracker (e.g., solar tracker 100), and the robotic tool may fold (e.g., close) the tabs over the first set of solar module panel frames, and inserts (e.g., drives) threaded fasteners into the tabs of the support rail and the first solar module panel frames, as referenced by block 630. The panel robot may then place a next set of solar module panels on the next support rail, as referenced by block 640. The robotic tool (e.g., robotic tool 450) may advance to the next desired location, and the robotic tool may fold (e.g., close) the tabs over the next solar module panel frames, and insert (e.g., drive) threaded fasteners into the tabs of the next support rail and the next solar module panel frames, as referenced by block 650. This process repeats until the last support rail of the first section of the solar tracker is complete, as referenced by block 660.

When the robotic tool closes the tabs on the last support rail of the first section and drives the threaded fasteners in, as referenced by block 670, the robotic tool may move on to a next section of the solar tracker and repeat the cycle of coupling solar module frames to support rails, as referenced by block 680.

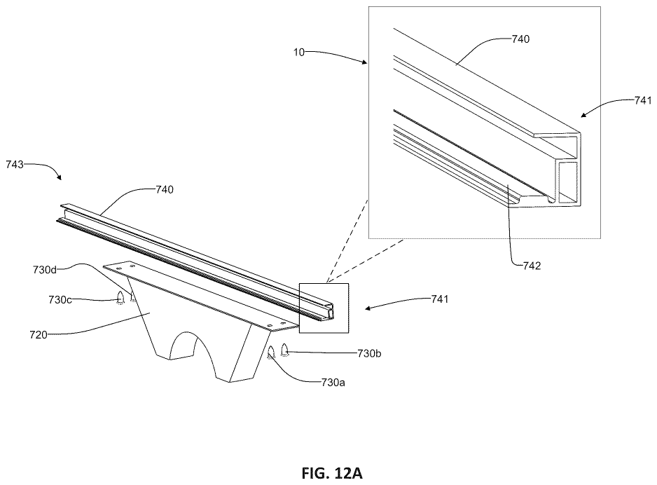

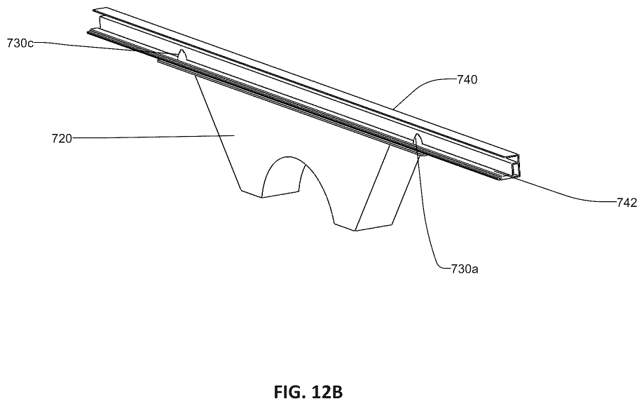

FIG. 12A is a solar module frame 740 in accordance with the disclosure, and FIG. 12B is the solar module frame 740 coupled to a support rail 720. As previously discussed, solar module frames formed from aluminum may be thin, and somewhat weak. Therefore, it may be desirable to provide a solar module frame having a greater thickness than a that of a standard solar module frame. For example, a standard solar module frame may include a thickness of about 1 millimeter (mm) to about 1.5 mm. The solar module frame 740 shown in FIGS. 12A to 12B may include a flange region 742 having an increased thickness of about 2 mm to about 4 mm, which may be an increase of about 50% to about 400% from the standard size, as shown in further detail within Square C.

Formation of the solar module frame 740 may be accomplished via adding an additional amount of raw material during an extrusion process to thereby create the thicker profile, as illustrated by a first end 741 of the solar module frame 740 in Square C. A robotic tool, such as robotic tool 450 described herein, may then couple the solar module frame 740 to the support rail 720 via a plurality of threaded fasteners, e.g., a first threaded fastener 730a and a third threaded fastener 730c, as shown in FIG. 12B. A second threaded fastener 730b and a fourth threaded fastener 730d may be used to couple a second solar module frame to the support rail 720, although this is not shown in FIGS. 12A to 12B.

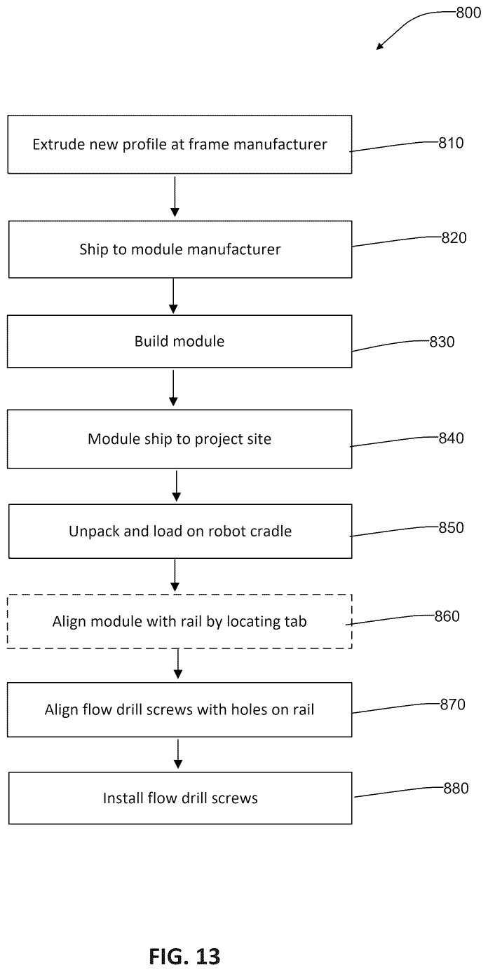

FIG. 13 is a flow chart of a method 800 of coupling the solar module frame 740 to the support rail 720. A first step of the method 800 may include extruding a new profile solar module frame (e.g., solar module frame 740) at a frame manufacturer, as referenced by block 810. The new solar module frame 740 may then be shipped to the solar module manufacturer, as referenced by block 820, and the solar module manufacturer may build a solar module using the new solar module frame 740, as referenced by block 830. The solar module panel may then be shipped to a project site, such as, for example, a desired location within a solar tracker, as referenced by block 840, and the solar module may be unpacked and loaded onto a panel robot cradle, as referenced by block 850. In some examples, the panel robot may align the solar module with the support rail 720 via one or more locating tabs, as referenced by block 860, although this is not necessary, as indicated by the dashed lines. A robotic tool (e.g., robotic tool 450) may then be used to align threaded fasteners with one or more holes within the support rail 720, as referenced by block 870, and the robotic tool may then insert the threaded fasteners, as referenced by block 880.

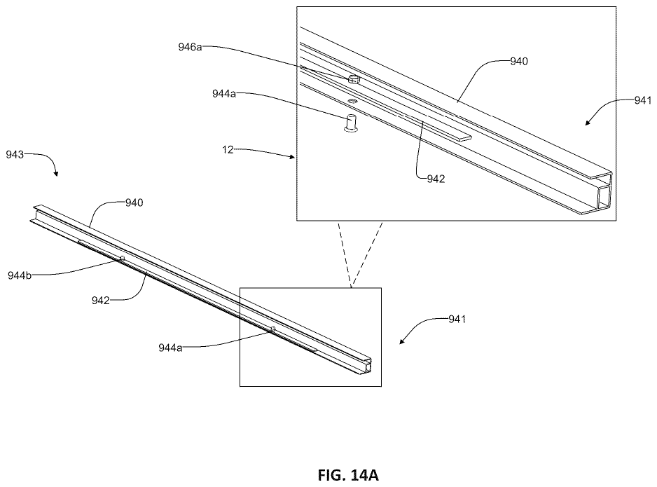

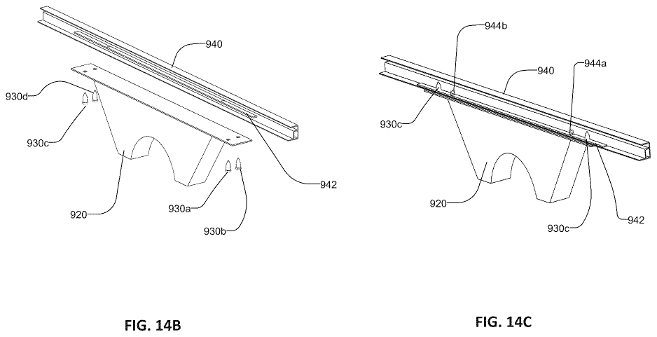

FIG. 14A is a solar module frame 940 in accordance with the disclosure, FIG. 14B is the solar module frame 940 prior to coupling to a support rail 920, and FIG. 14C is the solar module frame 940 coupled to the support rail 920. As previously discussed, solar module frames formed from aluminum may be thin, and somewhat weak. Therefore, it may be desirable to provide a solar module frame having a greater thickness than a that of a standard solar module frame. For example, a standard solar module frame may include a thickness of about 1 millimeter (mm) to about 1.5 mm. The solar module frame 940 shown in FIGS. 14A to 14C may include a back plate 942 adhered to the solar module frame 940, which may increase the thickness of the solar module frame 940 to about 2 mm to about 4 mm, which may be an increase of about 50% to about 400% from the standard size as shown in further detail in Square D.

Formation of the solar module frame 940 may be accomplished by preinstalling the back plate 942 to the solar module frame 940 via a clinch, to thereby create the thicker profile, as illustrated by a first end 941 of the solar module frame 940 in Square D. The back plate 942 may be coupled to the solar module frame 940 via a bolt 944a and a nut 946a, as shown in Square D. In other examples, the back plate 942 may be coupled to the solar module frame 940 via adhesives, a blind rivet, or any other suitable method of attachment. A robotic tool, such as robotic tool 450 described herein, may then couple the solar module frame 940 to the support rail 920 via a plurality of threaded fasteners, e.g., a first threaded fastener 930a and a third threaded fastener 930c, as shown in FIG. 14C. A second threaded fastener 930b and a fourth threaded fastener 930d may be used to couple a second solar module frame to the support rail 920, although this is not shown in FIGS. 14A to 14C.

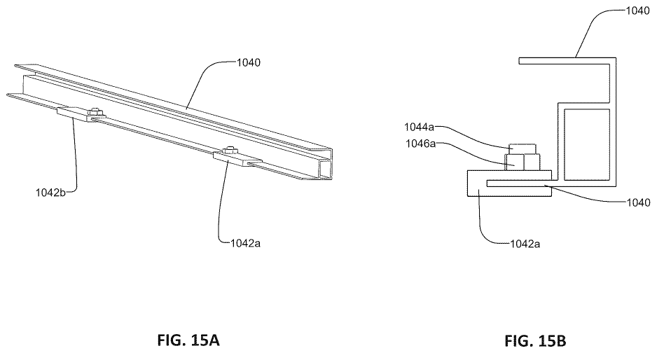

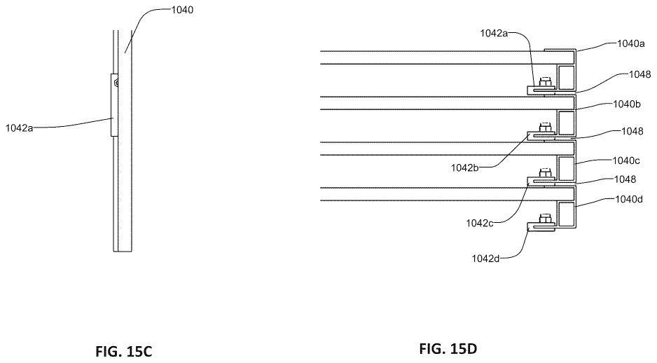

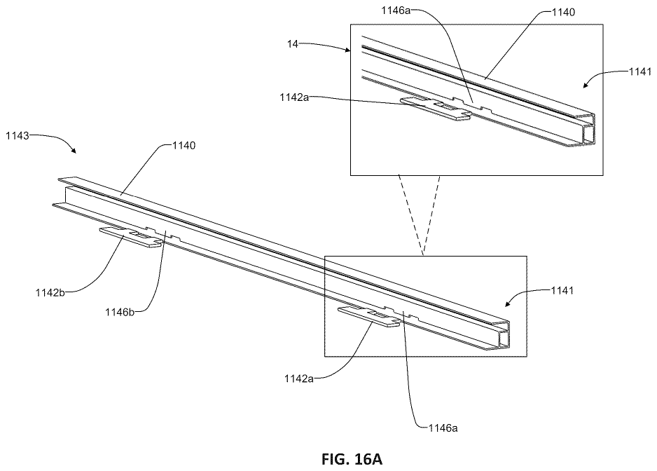

FIG. 15A is a solar module frame 1040 in accordance with the disclosure, FIG. 15B is a side end view of the solar module frame 1040, FIG. 15C is a top view of the solar module frame 1040, and FIG. 15D is a top side view of a plurality of solar module frames 1040, configured for packaging. As previously discussed, solar module frames formed from aluminum may be thin, and somewhat weak. Therefore, it may be desirable to provide a solar module frame having a greater thickness than a that of a standard solar module frame. For example, a standard solar module frame may include a thickness of about 1 millimeter (mm) to about 1.5 mm. The solar module frame 1040 shown in FIGS. 15A to 15D may include a first C-clip 1042a and a second C-clip 1042b coupled to the solar module frame 1040, which may increase the thickness of the solar module frame 1040 in those locations to about 2 mm to about 4 mm, which may be an increase of about 50% to about 400% from the standard size as shown in further detail in FIG. 15B.

Formation of the solar module frame 1140 may be accomplished by preinstalling the C-clips 1042a, 1042b to the solar module frame 1040 via a bolt 1044a and a nut 1046a, to thereby create the thicker profile, as illustrated by a first end 1041 of the solar module frame 1040 in FIG. 15B. The C-clips 1042a, 1042b may be coupled to the solar module frame 1040 via the bolt 1044a and the nut 1046a, as shown in FIG. 15B, however, in other examples, the C-clips 1042a, 1042b may be coupled to the solar module frame 1040 via adhesives, a blind rivet, or any other suitable method of attachment. A robotic tool, such as robotic tool 450 described herein, may then couple the solar module frame 1040 to a support rail via a plurality of threaded fasteners, although this is not explicitly shown in FIGS. 15A to 15D.

As shown in FIGS. 15C and 15D, the C-clip 1042a may extend beyond an edge of the solar module frame 1040. In this way, the C-clip 1042a may act as a spacer when packaging multiple solar module frames 1040 together at a frame manufacturer. A space 1048 provided by the C-clips 1042a, 1042b, 1042c, 1042d may help prevent direct contact of each solar module frame 1040 with each adjacent solar module frame, thereby preventing disruption and/or rupture of an aluminum anodization layer on each solar module frame 1040. For example, the C-clip 1042a coupled to the solar module frame 1040a may instead contact the solar module frame 1040b, thereby preventing direct contact between the solar module frame 1040a and the solar module frame 1040b by adding the space 1048 therebetween.

The added space 1048 may additionally provide room for a user to more easily grab the solar module frame and unpack the solar module frames at the solar module manufacturer. Typically, cardboard corner protectors are a common solution for module packaging and transportation. However, extra effort is needed when placing the cardboard corner protectors on the solar module frames at the frame factory, taking the cardboard corner protectors off the solar module frames at the solar module manufacturer, and collecting and throwing the cardboard corner protectors away. This further creates more waste. By including the C-clips 1042a, 1042b, 1042c, 1042d users can replace the cardboard corner protectors, thereby reducing cardboard waste, and reducing assembly time.

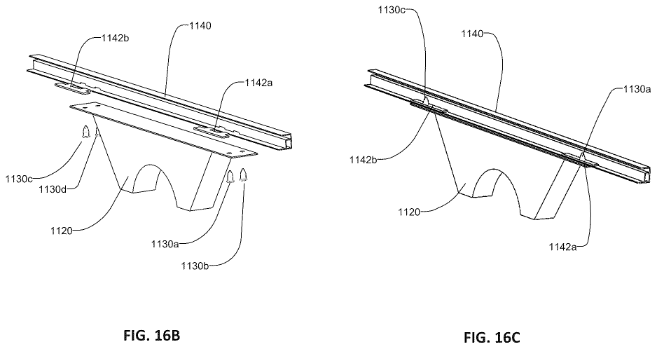

FIG. 16A is a solar module frame 1140 in accordance with the disclosure, FIG. 16B is the solar module frame 1140 prior to coupling to a support rail 1120, and FIG. 16C is the solar module frame 1140 coupled to the support rail 1120. As previously discussed, solar module frames formed from aluminum may be thin, and somewhat weak. Therefore, it may be desirable to provide a solar module frame having a greater thickness than a that of a standard solar module frame. For example, a standard solar module frame may include a thickness of about 1 millimeter (mm) to about 1.5 mm. The solar module frame 1140 shown in FIGS. 16A to 16C may include a first back plate 1142a and a second back plate 1142b coupled to the solar module frame 1140, which may increase the thickness of the solar module frame 1140 to about 2 mm to about 4 mm, which may be an increase of about 50% to about 400% from the standard size as shown in further detail in Square E.

Formation of the solar module frame 1140 may be accomplished by preinstalling the back plates 1142a, 1142b to the solar module frame 1140 within a first slot region 1146a and a second slot region 1146b, respectively, to thereby create the thicker profile in these regions, as illustrated by a first end 1141 of the solar module frame 1140 in Square E. The first back plate 1142a and the second back plate 1142b may be coupled to the solar module frame 1140 via interference fit. In other examples, the back plates 1142a, 1142b may be coupled to the solar module frame 1140 via adhesives, a blind rivet, a bolt, screw, or any other suitable method of attachment. A robotic tool, such as robotic tool 450 described herein, may then couple the solar module frame 1140 to the support rail 1120 via a plurality of threaded fasteners, e.g., a first threaded fastener 1130a and a third threaded fastener 1130c, as shown in FIG. 16C. A second threaded fastener 1130b and a fourth threaded fastener 1130d may be used to couple a second solar module frame to the support rail 1120, although this is not shown in FIGS. 16A to 16C.

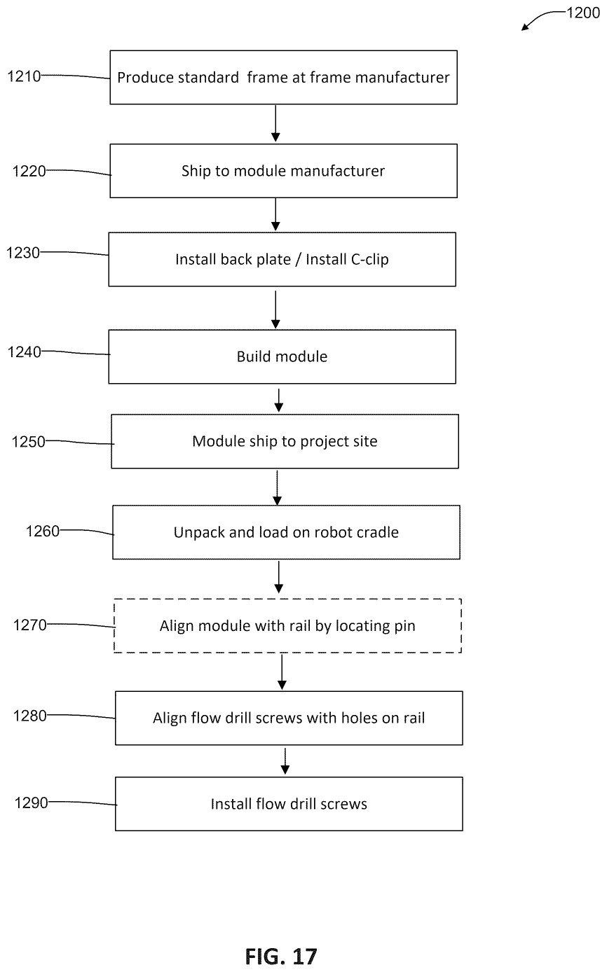

FIG. 17 is a flow chart of a method 1200 of coupling the solar module frames 940, 1040, 1140 to a support rail (e.g., support rail 920, 1120). A first step of the method 1200 may include producing a standard solar module frame (e.g., solar module frame 940, 1040, 1140) at a frame manufacturer, as referenced by block 1210. The solar module frame may then be shipped to the solar module manufacturer, as referenced by block 1220, and the solar module manufacturer may install a back plate (e.g., back plate 942, 1142a, 1142b) or a C-clip (C-clip 1042a, 1042b) as referenced by block 1230, and build the solar module, as referenced by block 1240. The solar module panel may then be shipped to a project site, such as, for example, a desired location within a solar tracker, as referenced by block 1250, and the solar module may be unpacked and loaded onto a panel robot cradle, as referenced by block 1260. In some examples, the panel robot may align the solar module with the support rail via one or more locating tabs, as referenced by block 1270, although this is not necessary, as indicated by the dashed lines. A robotic tool (e.g., robotic tool 450) may then be used to align threaded fasteners with one or more holes within the support rail, as referenced by block 1280, and the robotic tool may then insert the threaded fasteners, as referenced by block 1290.

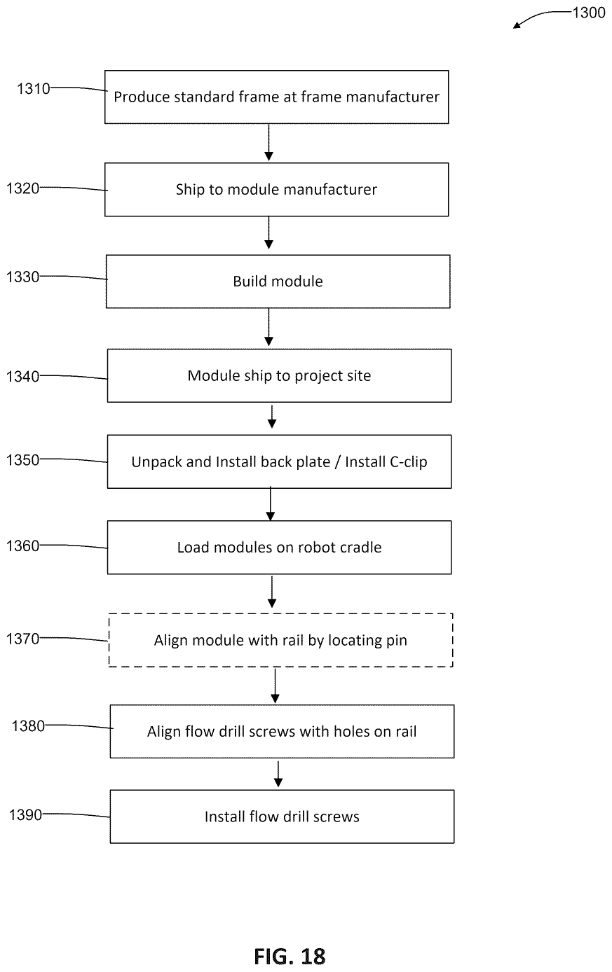

FIG. 18 is a flow chart of a second method 1300 of coupling the solar module frames 940, 1040, 1140 to a support rail (e.g., support rail 920, 1120). A first step of the method 1300 may include producing a standard solar module frame (e.g., solar module frame 940, 1040, 1140) at a frame manufacturer, as referenced by block 1310. The solar module frame may then be shipped to the solar module manufacturer, as referenced by block 1320, and the solar module manufacturer may build the solar module, as referenced by block 1320. The solar module panel may then be shipped to a project site, such as, for example, a desired location within a solar tracker, as referenced by block 1340, and the solar module may be unpacked and a user may install a back plate (e.g., back plate 942, 1142a, 1142b) or a C-clip (C-clip 1042a, 1042b) on the solar module frame, as referenced by block 1350. The solar panels may then be loaded onto a panel robot cradle, as referenced by block 1360. In some examples, the panel robot may align the solar module with the support rail via one or more locating tabs, as referenced by block 1370, although this is not necessary, as indicated by the dashed lines. A robotic tool (e.g., robotic tool 450) may then be used to align threaded fasteners with one or more holes within the support rail, as referenced by block 1380, and the robotic tool may then insert the threaded fasteners, as referenced by block 1390.

Various non-limiting exemplary embodiments have been described. It will be appreciated that suitable alternatives are possible without departing from the scope of the examples described herein.

What is claimed is:

1. A method of coupling one or more solar module frames to one or more support rails, the method comprising the steps of:
moving a tab at a support rail from a first tab position to a second tab position, the support rail interfacing with a solar module frame; and
when the tab is moved to the second tab position, actuating a fastening member at the solar module frame and at the tab in the second tab position.

2. The method of claim 1, wherein the tab is spaced further from the solar module frame in the first tab position than in the second tab position.

3. The method of claim 2, wherein moving the tab from the first tab position to the second tab position comprises moving the tab closer to the solar module frame.

4. The method of claim 3, wherein moving the tab from the first tab position to the second tab position comprises folding the tab toward the solar module frame.

5. The method of claim 4, wherein the tab comprises a perforated region configured to induce folding of the tab, and wherein folding the tab toward the solar module frame comprises folding the tab about the perforated region.

6. The method of claim 4, wherein folding the tab toward the solar module frame comprises folding the tab from the first tab position that is generally orthogonal to the solar module frame and generally orthogonal to a torque tube at which the support rail sits to the second tab position that is over or under the solar module frame and with the tab laying in a plane that is generally parallel to the torque tube at which the support rail sits.

7. The method of claim 1, wherein when the tab is moved to the second tab position, the fastening member is inserted through each of the solar module frame and the tab that is in the second tab position and actuated at the solar module frame and at the tab in the second tab position.

8. The method of claim 7, wherein the fastening member comprises a threaded fastener.

9. The method of claim 1,
wherein a tool is engaged at the tab to move the tab from the first tab position to the second tab position, and
wherein, after the tool has been used to move the tab to the second tab position and while the tool is engaged at the tab, actuating the fastening member at the solar module frame and at the tab in the second tab position using the tool.

10. The method of claim 9,
wherein the support rail comprises a locating tab, and
wherein engaging the tool at the tab to move the tab comprises using the locating tab at the support rail to position the tool in engagement with the tab.

11. The method of claim 10, wherein the support rail comprises a pilot hole, and wherein engaging the tool at the tab to move the tab comprises using the locating tab at the support rail to position the tool both in engagement with the tab and aligned with the pilot hole.

12. The method of claim 9,
wherein the tool engages the tab at a notch of the tool to fold the tab from the first tab position to the second tab position, and
wherein, after folding the tab from the first tab position to the second tab position and while the tab is engaged at the notch of the tool, actuating the fastening member through the notch and into the solar module frame and tab at the second tab position.

13. The method of claim 9,
wherein the tool comprises a robotic tool having a first arm tool and a second arm tool,
wherein the tab is a first tab of the support rail, and wherein the support rail further comprises a second tab at a same side of the support rail as the first tab,
wherein the first arm tool engages the first tab at a first notch of the first arm tool to fold the first tab from the first tab position to the second tab position, and
wherein the method further comprises:
with the second arm tool, engaging the second tab at a second notch of the second arm tool to fold the second tab from the first tab position to the second tab position; and
after folding the second tab to the second tab position and while the second tab is engaged at the second notch of the second arm tool, actuating a second fastening member at the solar module frame and at the second tab in the second tab position.

14. The method of claim 13, wherein the first arm tool and the second arm tool simultaneously engage and fold the respective first and second tabs.

15. A robotic tool for coupling a solar module frame to a support rail of a solar tracker, the robotic tool comprising:
a notch that is configured to receive a tab of a support rail, wherein, when the tab is received at the notch, the tool is configured to fold the tab toward the solar module frame; and
a fastening member driver aligned with the notch to drive a fastening member into the notch and through the tab when the tab is folded toward the solar module frame.

16. The robotic tool of claim 15, wherein the notch is a first notch and the fastening member driver is a first fastening member driver, and wherein the robotic tool further comprises:
a first arm comprising the first notch and the first fastening member driver; and
a second arm spaced apart from the first arm, the second arm comprising:
a second notch that is configured to receive a second tab of the support rail, wherein, when the second tab is received at the second notch, the second arm is configured to fold the second tab toward the solar module frame, and
a second fastening member driver aligned with the second notch to drive a second fastening member into the second notch and through the second tab when the second tab is folded toward the solar module frame.

17. A method of coupling one or more solar module frames to one or more support rails, the method comprising the steps of:
placing a solar module frame at a support rail, wherein the solar module frame comprises a coupling region that includes an increased profile thickness relative to an adjacent region at the solar module frame, wherein the support rail is configured to sit at a torque tube of a solar tracker;
after the solar module frame has been placed at the support rail, actuating a fastening member at the support rail and at the coupling region at the solar module frame.

18. The method of claim 17, wherein the fastening member comprises a threaded fastener.

19. The method of claim 17, wherein the coupling region at the solar module frame comprises a back plate member installed at the solar module frame prior to placing the solar module frame at the support rail.

20. The method of claim 17, wherein the coupling region at the solar module frame comprises a C-clip member installed at the solar module frame prior to placing the solar module frame at the support rail.
